(19) United States
(12) Patent Application Publication
(10) Pub. No.: US 2017/0106574 A1
(43) Pub. Date: Apr. 20, 2017

(54) SYSTEM AND METHOD OF MANUFACTURING A FIELD JOINT COATING

(71) Applicant: Heerema Marine Contractors Nederland SE, Leiden (NL)

(72) Inventors: Giuliano GANDOLFI, Leiden (NL); Helen Rose BOYD, Leiden (NL)

(21) Appl. No.: 15/300,678

(22) PCT Filed: Apr. 3, 2015
(86) PCT No.: PCT/NL2015/050218

§ 371 Date: Sep. 29, 2016

(30) Foreign Application Priority Data
Apr. 4, 2014 (NL) 2012572

(51) Int. Cl. B29C 45/14; B29B 7/74; F16L 58/18; B29C 45/46; B29C 45/72; F16L 13/02; B29B 7/88; B29C 45/00

(52) U.S. Cl. CPC B29C 45/14598; B29B 7/88; B29B 7/7471; B29C 45/0001; B29C 45/46; B29C 45/72; F16L 13/0272; F16L 58/181; B29C 2045/465; B29K 2083/00

(57) ABSTRACT

The present invention relates to a system (100) for manufacturing a Field Joint Coating (11), the system comprising: a heating device (102) for heating a quantity of a polymer, an upstream pump (104) for pumping the quantity of heated polymer into a storage compartment (106) of an ejection device (108), the ejection device (108) which is constructed for each time ejecting the heated polymer from its storage compartment, the ejection device comprising: o a barrel (1 10) which defines the storage compartment, the barrel being reinforced and configured for repeated use, o a plunger (1 1), o an actuator (1 14) for driving the plunger through the barrel for emptying the storage compartment, a downstream pump, the downstream pump being constructed for increasing the operating pressure of the ejected polymer, —a mould (200) configured to be positioned at a field joint (13) around a pipeline.

### FIELD OF THE INVENTION

The present invention relates to a system and method for manufacturing a Field Joint Coating (FJC) on a welding joint in a pipeline or a pipe section. In the prior art, devices for manufacturing a Field Joint Coating are known.

### BACKGROUND OF THE INVENTION

In the process of laying a pipeline, in particular for transporting hydrocarbons (oil & gas), pipe sections need to be welded to one another to form the pipeline. Generally, many pipe sections need to be welded to one another to form the pipeline.

Generally, the pipeline needs to be provided with a coating. This is generally the case when the pipeline is laid in a marine environment. The coating performs multiple functions. One function is thermal insulation. The hydrocarbons which are transported through the pipeline may be warm or even hot when they flow from the borehole. The surrounding (sea) water is generally relatively cold. If the temperature of the hydrocarbons drops too far during transport through the pipeline, asphaltenes, waxes or hydrates may separate from the hydrocarbons and be deposited on the inner wall of the pipeline. This may increase friction of the flow, reduce the capacity of the pipeline and ultimately cause clogging of the pipeline. The coating on the pipeline has the function of providing thermal insulation to limit a drop in temperature of the hydrocarbons during transport through the pipeline.

Another function of the coating is to provide a mechanical protection against potentially damaging events from outside, for instance if the pipeline is hit by an external object. The coating mechanically protects the pipeline from being damaged by corrosion as a result of such an event and ultimately prevents leaking as a result of such events.

Generally, a large part of the coating on the pipeline is applied prior to the welding process. Each pipe section is coated along the larger portion of its length prior to the welding process. This coating process is generally carried out in a factory in a controlled environment and is often called “line pipe coating”.

In the field, the free ends of each pipe section however need to be free of coating in order to allow welding of the pipe sections to one another. This may be carried out by removing a portion of the line pipe coating near the ends. After the welding, a gap in the coating therefore remains at the welding zone. A short section of coating needs to be applied in the gap for the above mentioned reasons, i.e. thermal insulation and mechanical protection.

This relatively short coating section is generally called a Field Joint Coating, or short FJC. The term Field Joint Coating relates to a coating which is made in the field, i.e. outside a controlled environment such as a factory. This may be on board a pipeline laying vessel or in a spoolyard. The FJC therefore is a coating which is manufactured over a relatively short length of pipeline in the region of a weld between two abutting pipe sections.

The laying of a pipeline in a marine environment is a time critical process. Pipeline laying vessels are extremely complex and have high daily costs. Therefore, the speed with which a pipeline can be laid is a decisive factor in the overall costs of laying the pipeline.

A characteristic of the Field Joint Coating is that it is generally made in the critical path of the pipeline laying process. This is different from the above mentioned line pipe coating, which is manufactured outside of the critical path. The time required to make the FJC is one of the factors which determines the overall speed with which the pipeline is laid, and hence the costs of the pipeline.

Often, the FJC needs to comply with high standards, i.e. strict requirements of quality. Therefore, the reliability of the process of FJC is also important and may play a part in the overall laying speed.

FJC's, particularly insulation FJC's, are currently made with an injection moulding process wherein PP (polypropylene) is injected into a mould around the pipeline at the welding zone, often under high pressure. Traditional FJC equipment therefore can be bulky on the pipe and have a large ‘footprint’ and take up substantial deck space on a pipelay vessel. The equipment also requires substantial time to install or remove.

An additional problem is the adhesion between the pipe coating and the FJC. Some known FJC systems require substantial bonding surface preparation do not easily bond well to many types of thermoplastic and thermoset pipe coatings. An easily repeatable, robust system is therefore required.

An additional problem with known polyurethane is the delicate mixing ratio of the two components, requiring stringent monitoring to ensure curing of the PU. A FJC material with a more robust mixing ratio is required.

A further problem of PU is that it tends to hydrolyse and therefore it is not suitable to be used with temperatures of hydrocarbons in the pipeline above about 80 degrees Celsius.

Although known FJC processes work, in the present invention it was recognized that substantial improvements are possible, in particular in terms of less bulky equipment, speed and robustness of the FJC application process, as well as setting rate of the FJC material. Further there is a need for coating materials that can withstand higher temperatures (>100 deg. C) and pressures due to high temperature pipelines are installed in deep waters of multiple kilometres of depth.

Therefore, there is a general need in the field of the art to be able to manufacture FJC's that can withstand high temperatures and high pressures in a fast and reliable process.

In a different field, a system is known from DE102008060493A1. This system is used for making profiles. This system is not suitable for making Field Joint Coatings, because it uses a heated extruder. The heated extruder is a combination of a pump and a heating device and pumps and heats the material at the same time. An extruder with an integrated heater is not effective for making Field Joint Coatings because it is not capable of handling the materials which are used for FJC's. Furthermore, the system of DE102008060493A1 is not configured for maintaining a temperature of the pumped polymer at a required level throughout the system. This further renders this system ineffective for making Field Joint Coatings.

### OBJECT OF THE INVENTION

It is an object of the invention to provide a method and device for manufacturing an FJC in a relatively fast and reliable way.

It is a further object of the invention to provide an alternative method and device for manufacturing an FJC.

### SUMMARY OF THE INVENTION

In order to achieve at least one object, the invention provides a system for manufacturing a Field Joint Coating, the system comprising:
a heating device for heating a quantity of a polymer,
an upstream pump for pumping the quantity of heated polymer into a storage compartment of an ejection device,
the ejection device which is constructed for each time ejecting the quantity of heated polymer from its storage compartment, the ejection device comprising:
   a barrel which defines the storage compartment, the barrel being reinforced and configured for repeated use,
   a plunger,
   an actuator for driving the plunger through the barrel from a start position to an end position for emptying the storage compartment, and
   a discharge opening,
a downstream pump positioned downstream from the ejection device, the downstream pump being constructed for increasing the operating pressure of the ejected polymer for injection of the polymer into a mould,
the mould which is configured to be positioned at a field joint of a pipeline or a pipe section.

In an embodiment, the invention provides a fast and reliable system of manufacturing a FJC. The invention is in particular suitable for silicone materials.

Silicone has a mildly exothermic reaction during curing when compared to the curing reaction of polypropylene. This results in less shrinkage during subsequent curing, and therefore less residual stresses. The reduced residual stresses results in less stress fractures in the bonding surface with the adjoining line coating.

Silicone also can withstand higher temperatures than commonly applied coating materials such as PP or PU. This is an advantage with hydrocarbons which have a relatively high temperature, for instance as a result of a deep location of a hydrocarbon field.

Silicone can be used as a two-component material, i.e. with a catalyst for speeding up the curing process. Due to the catalyst, the silicone FJC sets faster than a FJC manufactured from polypropylene, resulting in a faster overall process of laying a pipeline. The curing process of the silicone FJC can be further enhanced by raising the temperature of the silicone material which enters the mould, allowing the silicone FJC to set and de-moulded in a shorter amount of time compared to an equivalent PP FJC.

Silicone provides a further advantage in that it can be processed at a lower temperature than PP.

The use of silicone as insulation for an FJC is in itself known. WO2013/066170A1, which was also filed by the present patentee, discloses a method and device for manufacturing an FJC from silicone. See in particular FIG. 6 and the accompanying description on page 9, line 15-page 10, line 8. However, it was found that this method and device is slow and provides a varying quality of the FJC.

Silicone is also used for providing coatings to other sub-sea components than pipelines. These coatings are manufactured in a factory environment on shore and under controlled conditions In these applications, there typically is no critical path which requires high speeds as is the case in pipeline laying. Here, the silicone is applied in a relatively slow process. Typically, discharges of 6-8 kg per minute are achieved and curing times of several hours are used. The curing rate is very slow and therefore time before demoulding may take up to 24 hours. It was found that this process is too slow and not suitable for use in the manufacturing of an FJC on the critical path in a pipeline laying process where the time before demoulding, and potentially passing the field joint over a roller, should be in the order of minutes rather than hours. In the present invention the insight was developed that the current pumping systems for silicone do not permit a rate of discharge which is sufficient to apply a silicone material in an FJC within the time requirements that are typical of laying a pipeline in a marine environment,

In the known method of making insulation with silicone, a container which contains silicone material is heated in an oven. Subsequently, a top lid of the container is removed and the container is placed under a plunger of an ejection device. The plunger is then moved downward through the container and uses the container as a barrel of a syringe. The plunger presses the silicone through a discharge hole in the plunger when it moves downward.

It was recognized in the present invention that the use of the container as the barrel of a plunger in the critical path results in a slow process. In other words, the dual function of the container as a storage container and as a barrel for a plunger in the critical path results in slow and unreliable process. A container for holding silicone typically has a relatively thin wall which is not capable of withstanding high pressures. When the pressure becomes too high, the container ruptures. Further, the thin walled container is relatively flexible. This flexibility results in a delay in pressure build up.

In the present invention the insight was developed that the use of a dedicated ejection device of a syringe-type in the critical path having a dedicated barrel can substantially speed up the injection process of the mould and make it more reliable. The container for holding the silicone is no longer used as a barrel of an ejection device for injecting the polymer into the mould of the FJC but only serves as a storage container.

It will be understood that the container which holds the polymer will need to be emptied. A plunger type ejection device may still be used for this purpose. In this respect, the container may still serve as a barrel for a plunger. However, the container is emptied outside the critical path, i.e. it is not emptied during the making of the FJC, but prior to the making of the FJC.

In a pipeline laying cycle, many different operations need to be carried out. The pipe section needs to be 1) positioned in the firing line, 2) aligned with the pipeline, 3) welded to the pipeline. The weld then needs to be 4) inspected and 5) tested. After these operations have been carried out, the FJC is made. In the present invention, the container holding the heated polymer for the FJC may be emptied and pumped into the storage compartment by the upstream pump in a relatively slow process during steps 1-5. When the FJC is to be made, the dedicated ejection device comprising the barrel and plunger are ready to swiftly eject the heated polymer.

The heating process is also performed outside the critical path. The heated polymer is pumped into the ejection device and the ejection device is held on stand-by mode. When the FJC should be made, the ejection device ejects the heated polymer, in particular silicone.

Further, the current method of forming a FJC with polypropylene is not suitable to be used for silicone, because it would not permit the silicone FJC to set and de-moulded in a relatively short amount of time i.e. within the time requirements that are typical of laying a pipeline in a marine environment.

Furthermore, current FJC systems which operate with PP require the mould to be pressurized. This need for pressurization makes the equipment more bulky, cumbersome and makes the process of making the FJC prone to errors. The feature of maintaining the pressure in the mould substantially at atmospheric pressure allows less bulky equipment and a method which is less prone to errors.

In an embodiment, the heating device is separate from the upstream pump and is located upstream from the upstream pump, and the polymer is heated prior to entering the upstream pump. This feature makes the system very effective for silicones and other polymers which are used for making FJC's.

In an embodiment, the system comprises a jacket which extends around the barrel and a further heating system for heating a hot fluid, the heating system being configured for pumping the hot fluid through the jacket for maintaining the elevated temperature of the heated polymer inside the barrel. The heated barrel and the heating system are used for maintaining the elevated temperature of the polymer, which is very advantageous in achieving a high discharge at a reasonable pressure and making the FJC in a short period of time.

In an embodiment, a discharge channel extends from the ejection device in the direction of the mould, wherein a channel jacket is provided around at least a section of said discharge channel, and wherein the further heating system is configured to heat said part of the discharge channel by pumping a hot fluid through the jacket for maintaining the elevated temperature of the heated polymer inside the discharge channel. The heated discharge channel allows a high discharge at a reasonable pressure and is very advantageous for making the FJC in a short period of time.

In an embodiment, a volume of the storage compartment is at least 90 percent of a volume of the mould when positioned around the pipeline or pipe section. In case the system comprises multiple ejection devices for ejecting the heated polymer, the ejection devices will be arranged in parallel and the combined volume of the storage compartments of these ejection devices is at least 90 percent of the volume of the mould. This allows the process for making the FJC to fill the mould in one go, which is very advantageous in the time critical process of making FJC's.

In an embodiment, the reinforced barrel is capable of withstanding a pressure which created by the plunger and which is required to eject a total quantity of material which is sufficient to fill the volume of the mould for the FJC in a relatively short period of time, in particular within a period of time shorter than 2 minutes, more in particular shorter than 1 minute, and even more in particular in about 30 seconds. This short time period is possible with a dedicated ejection device, but not with a known storage container for polymers, in particular silicone.

In an embodiment, the upstream pump is configured to pump said quantity into the ejection device in a first time period, wherein the ejection device is configured to eject said quantity in a second time period, and wherein the length of the second time period is less than 20 percent of the length of the first time period. The making of the FJC typically is only a small portion of the entire pipe line laying cycle and the filling of the ejection device by the upstream pump may therefore be performed at a relatively slow rate.

If the system comprises multiple ejection devices positioned in parallel, each ejection device may be associated with a respective upstream and downstream pump. Alternatively, the ejection devices may share an upstream and/or downstream pump.

If a two component system is used as discussed further below, the storage compartment should be large enough to hold at least 90 percent of the volume of the mould when positioned around the pipeline. The second component, the catalyst, is mixed with the polymer and brings the total to 100 percent. If a single component system is used, the storage compartment should be able to hold at least 100 percent of the volume of the mould

It is conceivable to use multiple ejection devices in parallel. In that case, the combined storage compartments of the ejection devices should be able to hold at least 90 percent of the mould volume in a 2-component system and at least 100 percent in a one component system.

In an embodiment, the system is a 2-component system, the system further comprising a catalyst supply for supplying a catalyst for a curing reaction of the polymer and a mixing device for mixing the catalyst with the heated polymer, wherein in particular the mixing device is positioned downstream of the downstream pump. For certain polymers and in particular for silicone, a catalyst may substantially speed up the curing process.

In an embodiment, the catalyst supply comprises a catalyst storage compartment, a catalyst discharge opening and a catalyst pump for pumping the catalyst to the mixing device

In an embodiment, the system comprises
an oven,
a plurality of containers containing the polymer, wherein the containers are placed in the oven for a period of time for heating the polymer,

wherein the upstream pump is configured for each time emptying a container containing heated polymer.

In an embodiment, the upstream pump comprises:
an emptying position for the heated container,
a second plunger being positioned upstream from the first plunger and being configured to move through the container, and
a second actuator for driving the plunger from a first position to a second position.

This embodiment uses two plunger devices in series and combines the use of simple, standard containers for the polymer with a high injection rate and hence a short injection time.

An alternative for the oven may a heat exchanger through which the polymer is pumped. Alternatively or additionally, a heat exchanger may be provided downstream of the ejection device for adding heat to the ejected polymer.

In an embodiment, the containers contain silicone material, in particular comprising hollow microspheres dispersed within the silicone material. It was found that the silicone material is very suitable for making FJC's. It is a two-component material which, when heated, can set very quickly. The hollow microspheres, for instance glass microspheres, provide excellent and stable thermal insulation and a high hydrostatic pressure capability. The microspheres are supported by the silicone material. The material resists water ingress and does not hydrolyse and experiences limited shrinking during curing. The limited shrinkage results in reduced residual stresses in the FJC as it sets.

The polymer is pre-heated to about 80 degrees Celsius in order to obtain the required reaction rate in order to make the total FJC volume in the required time. The heating to 80 degrees lowers the viscosity and allows fast pumping. The ratios between the two components is not very critical, which makes the material practical, and robust for offshore use. In contrast, PU is very sensitive to the mixing ratio with the catalyst. A relatively small deviation in the ratio, which may occur in an offshore environment, can cause problems because the PU will not set.

Further, in an embodiment the equipment required for making an FJC with silicone material is significantly smaller and less complicated than the equipment required for application of an extruded polypropylene FJC. This equipment is easier and quicker to install.

Silicone can withstand higher temperatures in a marine environment than for instance polypropylene and polyurethane, and may withstand temperatures of up to 150 degrees Celsius.

In an embodiment, the downstream pump is a volumetric pump. A volumetric pump pumps a predetermined volume of material during one cycle. The discharge for a cycle is not dependent on the upstream or downstream pressure. It was found that this creates a predetermined discharge rate into the mould.

In an embodiment, the system comprises a purge device positioned downstream of the downstream pump, more in particular downstream of the mixing device and just upstream of the mould, and being configured for purging a quantity of material prior to injection of the polymer into the mould and/or purging a quantity of material after injection of the polymer into the mould.

The purge device is used to clean the mixing device prior to the manufacturing of the FJC by pumping silicone without catalyst through the mixing device. Subsequently, the FJC is made. After the FJC is made, the purge device is again used to clean the mixing device by pumping silicone without catalyst through the mixing device. In this way, a clogging of the mixing device can be prevented.

In an embodiment, a volume of the storage compartment is at least 30 litres, or the system comprises multiple ejection devices positioned in parallel, each ejection device is associated with a respective upstream and downstream pump, and the combined volume of the storage compartments of the ejection devices is at least 30 litres.

The volume required for the FJC depends on the diameter of the pipeline and may depend on other factors, such as the prevailing temperatures of the hydrocarbons and the surrounding water. It was found that these dimensions are suitable for a range of FJC's.

In an embodiment, the barrel has a steel wall having a thickness of at least 1 cm. The thick steel wall results in a very quick pressure build up once the actuator starts driving the plunger.

In an embodiment, the discharge opening is located in the end of the barrel opposite to the plunger. This end may be the bottom end. It was found that this creates a faster pressure build up than when the discharge opening is in the plunger. The discharge opening at the end of the barrel also results in a shorter channel between the ejection device and the downstream pump.

In an embodiment, the mixing device comprises a polymer inlet, a catalyst inlet, a mixing chamber and a rotatable mixing organ positioned inside the chamber, the rotatable mixing organ being driven by a drive. The rotatable mixing organ provides the benefit of good mixing at a limited head loss.

In an embodiment, the upstream pump is configured for pumping the quantity of heated polymer into the storage compartment prior to the injection of the polymer into the mould.

The present invention further relates to a method for manufacturing a Field Joint Coating, the method comprising:
heating a quantity of polymer,
pumping the heated polymer into a storage compartment of an ejection device with at least one upstream pump, the ejection device being constructed for each time ejecting the quantity of heated polymer from its storage compartment, the ejection device comprising:
   a barrel which defines the storage compartment, the barrel being reinforced and configured for repeated use,
   a plunger,
   an actuator for driving the plunger through the barrel from a start position to an end position for emptying the storage compartment, and
   a discharge opening,
ejecting the heated polymer from the storage compartment by the ejection device in a relatively short period of time,
increasing the operating pressure of the ejected polymer with a downstream pump which is positioned downstream from the ejection device, and
injecting the polymer into a mould which is positioned at a field joint around a pipeline or a pipe section,
letting the polymer set for forming the field joint coating.

The method provides the same benefits as the system.

In an embodiment of the method, the polymer is a silicone material, in particular a syntactic silicone material comprising glass microspheres dispersed within the silicone material.

In an embodiment of the method, the polymer is a thixotropic polymer. It was found that in particular with a thixotropic polymer the speed gain is substantial.

In an embodiment of the method, the polymer is heated to a temperature of at least 60 degrees Celsius, in particular to a temperature between 75-85 degrees Celsius.

In an embodiment of the method, the ejection device ejects the quantity of polymer at a rate of at least 40 kg/minute.

In an embodiment of the method, the ejection device ejects the quantity of polymer in relatively short time period, in particular a time period of less than two minutes, in particular less than 1 minute, and wherein the curing in the mould takes place in a time period of less than 10 minutes, in particular less than five minutes. These short time periods result in a relatively fast pipeline laying process.

In an embodiment, the method comprises performing pre-processing steps on a pipeline coating of the pipeline or pipe section adjacent to the FJC, the pre-processing steps comprising one or more of:
cleaning the pipeline coating with an abrasive action, for instance sand blasting,
heating the pipeline coating with a coating heating device,
changing the surface energy of the pipeline coating by performing a plasma-treating step, wherein an ionized material is sprayed onto the coating.

A primer may subsequently be applied on the pipeline. The pre-processing steps result in a subsurface which is suitable for manufacturing the FJC.

In an embodiment, the FJC is manufactured with a single pour.

In an embodiment of the method, the curing step of the polymer takes place in less than five minutes.

In an embodiment of the method, the polymer is a polymer which does not have an exothermic reaction during curing.

In an embodiment of the method, the polymer remains its integrity up to a temperature of 150 degrees.

In an embodiment of the method, the polymer is mixed with a catalyst for catalysing the curing process, and wherein the catalyst is mixed with the polymer downstream of the downstream pump in a mixing device.

In an embodiment of the method, the polymer is a thixotropic polymer.

In an embodiment of the method, the polymer is a silicone material.

In an embodiment of the method, the method is carried out on board a pipeline laying vessel or on a spoolyard.

These and other aspects of the invention will be more readily appreciated as the same becomes better understood by reference to the following detailed description and considered in connection with the accompanying drawings in which like reference symbols designate like parts.

### BRIEF DESCRIPTION OF THE FIGURES

FIG. 1 shows a sectional view of an area around a welding zone where an FJC is to be made.

FIG. 2 shows a detail of FIG. 1.

FIG. 3 shows another view of an area where an FJC is to be made.

FIG. 4 shows a diagrammatic view of a system according to the invention.

FIG. 5 shows an isometric view of the system according to the invention.

FIG. 6 shows a sectional side view of the ejection device.

FIG. 7 shows an isometric view of a mixing device and a purge device.

FIGS. 8A, 8B, 8C and 8D show isometric views of the mould halves.

FIG. 9 shows an isometric view of an FJC area.

FIG. 10A shows an isometric view of a mould around an FJC area of a vertical pipeline.

FIG. 10B shows a sectional view of a mould around an FJC area of a pipeline.

FIG. 10C shows an isometric view of a mould around an FJC area of a horizontal pipeline.

FIG. 11 shows an isometric view of a finished FJC.

### DETAILED DESCRIPTION OF THE FIGURES

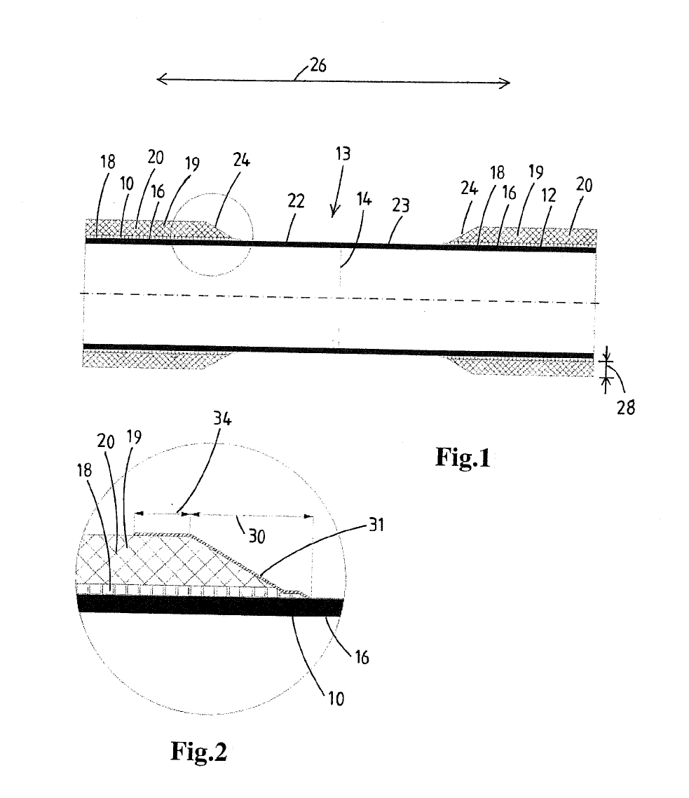

Turning to FIGS. 1, 2 and 3, a situation is shown which typically occurs in a pipeline laying process prior to the manufacturing of a Field Joint Coating. A first pipe section 10 and a second pipe section 12 have been welded to one another and together form a pipeline or a pipe section. The end faces of the pipe sections 10, 12 abut in a welding zone 14. This is called the Field Joint 13. The pipe sections 10, 12 each have a steel wall 16.

On the steel wall a corrosion protection 18 is provided which may be in the form of a three layers polypropylene (3LPP) consisting of a layer of Fusion Bonded Epoxy (FBE), a primer, and a layer of PP. An outer line pipe coating 19 covers the corrosion protection 18. The outer layer 19 of line pipe coating is for instance made from an insulating material (e.g. PP with glass spheres) covered by a protective layer of solid PP. The combination of corrosion protection 18 and outer layer layers 19 is known in the art as a multi-layer polypropylene (MLPP). The first and second layer together form the line pipe coating 20.

The ends 22, 23 of the pipe sections are free of any coating and are bare metal. The line pipe coating 20 ends at tapering faces 24 (or chamfered faces) on either side of the welding zone. A taper angle 21 of the second layer 19 may be about 15-45 degrees. A length 26 of the FJC may be around 50-100 cm. A thickness 28 of the coating may be between 5-15 cm. A chamfer length 30 may be about 5-30 cm.

Prior to the manufacturing of the FJC, a coating layer 32 is applied to the tapering face 24. The coating layer extends beyond the tapering face 24 over the outer surface of the line pipe coating 20 over a certain distance 34.

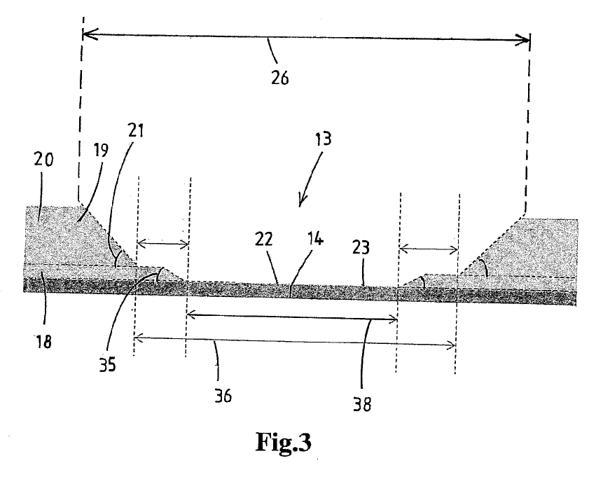

FIG. 3 shows that the taper angle 35 of the first layer 18 of line pipe coating differ somewhat from the taper angle 21 of the second layer 19 may be about 15-45 degrees.

A length 38 of the FJC at the foot of the first layer 18 of line pipe coating may be between 50 and 70 cm A length 36 of the FJC at the foot of the second layer 19 of line pipe coating may be between 60 and 80 cm.

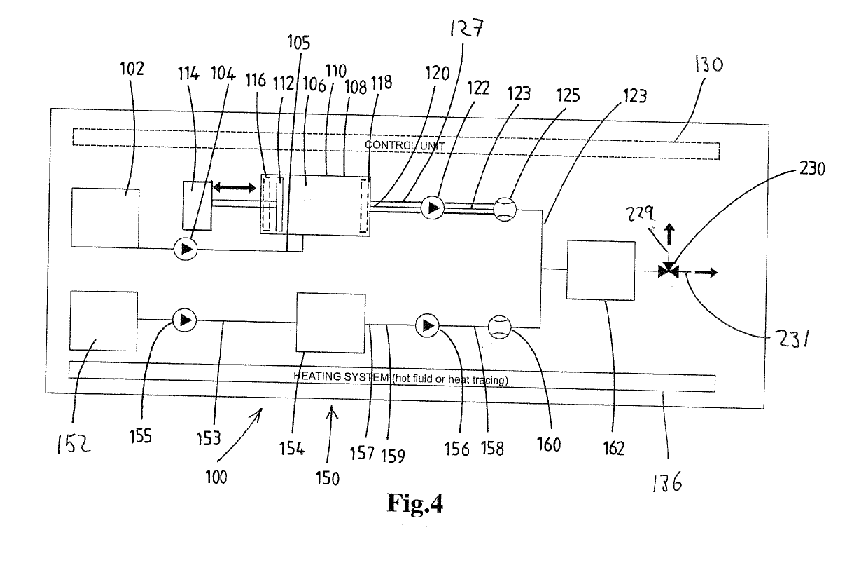

Turning to FIG. 4, a schematic diagram of the system 100 for manufacturing a Field Joint Coating 101 is provided. The system comprises a heating device 102 for heating a quantity of a polymer. The heating device 102 may be an oven in which containers which hold polymer are placed. In use, when a container has been heated to about 80 degrees in the oven, it is taken out of the oven. It is also possible that the heating device 102 is a large vessel with heating means. The system comprises a control unit 130 for controlling the different parts.

The system 100 further comprises an upstream pump 104 for relatively slowly emptying a container of heated polymer. The upstream pump 104 may be a plunger pump. The container is placed on an emptying position for the heated container, the emptying position comprising a connector via which the container can be connected to the upstream pump 104. The emptying of the container is performed outside the critical path, i.e. is not performed during the making of the FJC but as a preparatory step, prior to the injection into the mould. The upstream pump 104 is separate from the heating device 102, and the polymer is heated before entering the upstream pump 104. This is very different from the system of DE102008060493.

The container may have a thin wall, which allows cost-effective and light containers.

The upstream pump 104 is configured for pumping the quantity of heated polymer via a channel 105 into a storage compartment 106 of an ejection device 108. The ejection device 108 is constructed for each time ejecting the quantity of heated polymer from its storage compartment. The ejection device is a syringe type pump and comprises a barrel 110 which defines the storage compartment 106. The storage compartment is filled prior to the injection into the mould and there may be a waiting time period during which the heated polymer is kept in the storage compartment.

The barrel is reinforced and configured for repeated use. The ejection device further comprises a plunger 112 and an actuator 114 for driving the plunger through the barrel from a start position 116 to an end position 118 for emptying the storage compartment. The ejection device further comprises a discharge opening 120 at the bottom end 119 of the barrel 110. The direction of movement of the plunger 112 can be vertical and downwards.

The ejection device further comprises a downstream pump 122 positioned downstream from the ejection device 108 and connected to the ejection device 108 via a discharge channel. The downstream pump 122 is constructed for increasing the operating pressure of the ejected polymer for injection of the polymer into a mould. The downstream pump may 122 be a volumetric pump, in particular a lobe pump. A volumetric pump has a guaranteed discharge per cycle of the pump and will not have a reduced discharge per cycle as a result of a higher pressure downstream from the pump. A lobe pump has the particular advantage of high throughput and high pressure.

A discharge channel 123 extends from the downstream pump 122 via a flow meter 125 to a mixing device 162.

The system further comprises a purge device 230 for purging a quantity of polymer or a mixture of polymer and catalyst. The purge device 230 is located downstream from the mixing device 162 and has an exit 231 to which a hose 233 is connected which ends at the mould. The purge device has an exit 229 via which the polymer or the mixture of polymer and catalyst is purged.

The system 100 further comprises the mould 200, which is discussed in connection with and shown in figures. The mould 200 is configured to be positioned at a field joint around a pipeline or a pipe section.

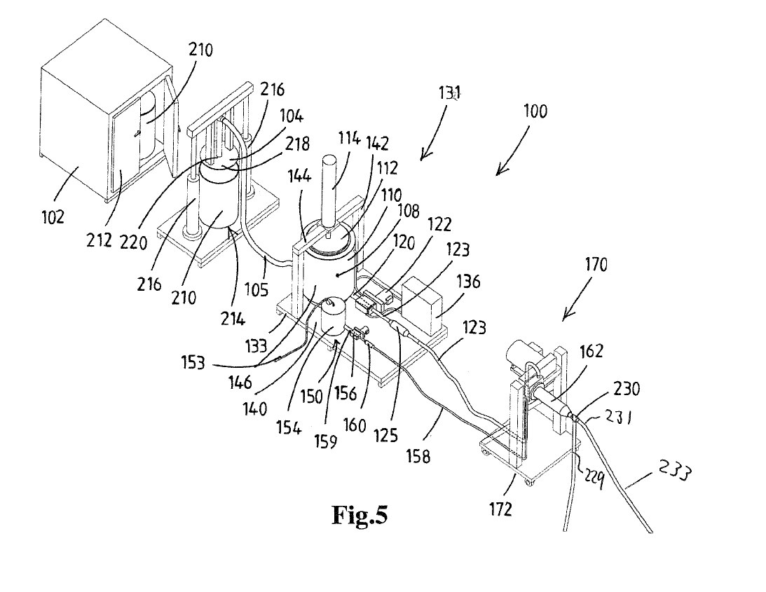

Turning to FIG. 5, the system 100 is shown in an isometric view. The heating device in the form of an oven 102 is configured to hold multiple containers 210. The oven has doors 212. The containers are heated in several hours to a temperature of about 80 degrees. Next, a container 210 is removed from the oven. The lid is removed and the container is placed on the emptying position 214. The emptying position is located underneath the upstream pump 104 which comprises a plunger device 216 which is operated by a hydraulic ram. The plunger 218 comprises a discharge hole 220 through which the polymer leaves the container. In this way, no holes in the container need to be made, and only the top lid needs to be removed.

A number of the parts which form the system are arranged as a first modular unit 131 on a first frame 133. A number of the parts are arranged as a second modular unit 170 on a second frame 172.

The first modular unit 131 comprises the ejection device 108 which is mounted between a base 140 of the frame and a portal 142 of the frame. The base 140 comprises several longitudinal beams and cross-beams. The integral configuration in a modular unit allows fast installation and removal of the system 100 on board a vessel.

The actuator 114 and plunger 112 are supported by a horizontal beam 144 of the portal. The barrel 110 is supported by the base 140. The reinforced barrel 110 is capable of withstanding a pressure which is created by the plunger and which is required to eject a total quantity of material which is sufficient to fill the volume of the mould for the FJC in a relatively short period of time. The mould may in particular be filled within a period of time shorter than 2 minutes, more in particular shorter than 1 minute, and even more in particular in about 30 seconds.

The upstream pump 104 is configured to pump said quantity of heated polymer into the ejection device 108 in a first time period. The ejection device 108 is configured to eject said quantity in a second time period. The length of the second time period is less than 20 percent of the length of the first time period. In this way, the filling of the storage compartment with heated polymer can be performed prior to the injection of the mould, in particular during positioning of a pipe section, aligning of a pipe section, welding, inspecting of the weld or testing of the weld.

The actual ejection of the heated polymer from the ejection device 108 takes place in a relatively short period of time, so that the FJC is manufactured very rapidly.

The ejection device 108 is shown with a jacket 146 partially cut away. The jacket defines a volume around the barrel 110 in which hot water is kept in order to maintain the elevated temperature of the polymer in the storage compartment 106.

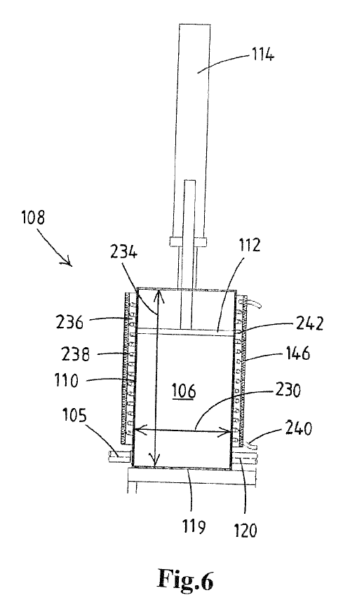

Turning to FIG. 6, further details of the ejection device 108 are shown. The barrel 110 has a diameter 232 of at least 30 cm and a length 234 of at least 30 cm. The reinforced barrel 110 is provided with a jacket 146 which defines a hot water volume 236 around the barrel 110. A coil 238 extends inside the hot water volume. The coil is a hot water channel which is fed with hot water (or another fluid suitable for heating such as oil) from a second heating system 136 via a channel 240. The hot water inside the coil heats the hot water in the jacket, which in turn keeps the temperature of the polymer at the required level. The barrel 110 has a steel wall 242 having a thickness of at least 1 cm. The wall 242 may have further reinforcements to prevent deformation during the ejection process. The barrel 110 is significantly stronger than the container 210 in which the polymer is stored.

The second heating system 136 is further configured to heat the discharge channel 123 which extends from the ejection device 108 via a flow meter 125 to a mixing device 162. To this end, the discharge channel 123 is provided with a channel jacket 127 (indicated in FIG. 4) through which a hot fluid such as oil or water is pumped. The entire discharge channel 123 between the ejection device 108 and the mixing device 162 may be heated, or a part thereof. The hose 233 may also be provided with a jacket and be connected to the second heating device 136 for heating the polymer inside the hose 233.

The discharge opening 120 is located at the bottom end of the barrel 110, which is different from the configuration of the upstream pump 104. It was found that this location increases the discharge, because the channel 123 can be shorter.

A volume of the storage compartment 106 is at least 30 litres. If the system comprises multiple ejection devices positioned in parallel, each ejection device is associated with a respective upstream and downstream pump, and the combined volume of the storage compartments of the ejection devices is at least 30 litres.

Typically, a volume of the storage compartment 106 is at least 90 percent of a volume of the mould. In practice, the volume of the mould depends on the diameter of the pipeline and the thickness of the insulation layer. The volume of the storage compartment may be tuned to a maximum diameter of the pipeline and coating layer thickness. For smaller pipelines or thinner layers, the FJC can be made by filling the storage compartment with a smaller quantity as a result of which the plunger 112 makes a smaller stroke.

The system may comprise multiple ejection devices 108 which are positioned in parallel and which eject a smaller quantity of heated polymer simultaneously. In an embodiment, each ejection device may be associated with a respective upstream pump and a respective downstream pump. The channels from the respective downstream pumps may merge in a manifold. In case of a 2-component system, which will be explained further below, the combined volumes of the storage compartments of the ejection devices 108 would be at least 90 percent of the volume of the mould.

Returning to FIGS. 4 and 5, the system 100 is a 2-component system. In this case, the system 100 further comprises a catalyst supply 150 for supplying a catalyst for a curing reaction of the polymer.

The catalyst supply 150 comprises a catalyst storage compartment 154. The catalyst storage compartment 154 is essentially a vessel which is fed by a relatively slow feed pump 155 which pumps the catalyst from an upstream storage 152. The catalyst is in a liquid condition in the upstream storage and the slow rate feed pump 155 is separate from the upstream storage 152. The slow rate feed pump 155 is coupled to the catalyst storage compartment via feed channel 153. The catalyst storage compartment 154 has a discharge opening 157 and a discharge channel via which it is connected to a gear pump 156. The gear pump 156 is configured to pump the catalyst from the storage compartment 154 via channel 159 and to pump the catalyst through a discharge channel 158 which extends via a flow meter 160 to a mixing device 162. The gear pump 156 is configured to maintain the discharge of the catalyst with the discharge of the ejection device 108 in the required ratio. The ratio between the polymer and the catalyst may typically be 10:1, but this may vary somewhat.

Two channels extend from the first modular unit 131 to the second modular unit A first channel 123 conveys the polymer, while a second channel 158 conveys the catalyst.

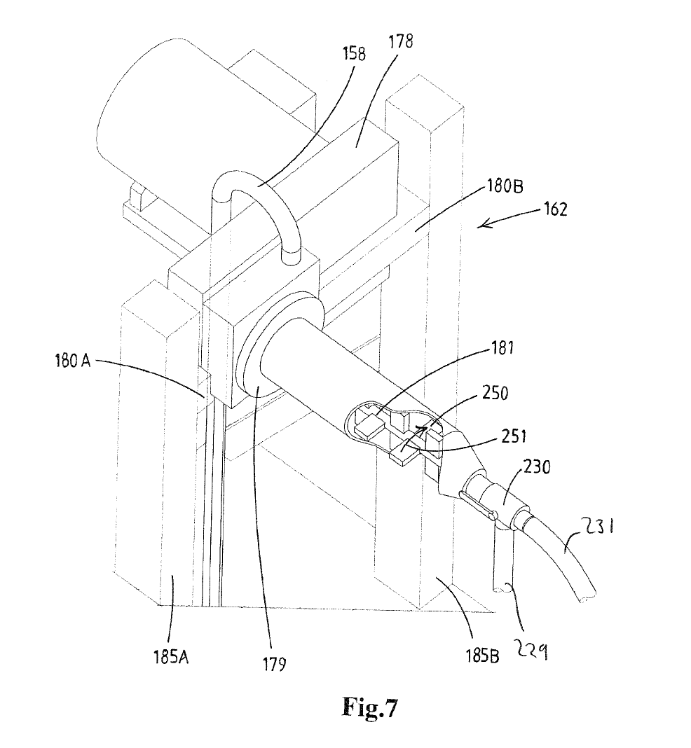

Turning to FIG. 7, the system comprises a second unit 170. The second unit 170 comprises a frame 172 mounted on cantor wheels 174. A vertical support beam 175 supports a platform 176. The platform supports the mixing device 162. The mixing device 162 is positioned downstream of the downstream pump 122. Typically, the mixing device is positioned downstream from the flow meter 125.

The mixing device 162 further comprises a polymer inlet connector of a manifold. The polymer inlet connector is to be connected to the channel 123 shown in FIGS. 4 and 5. The manifold splits the polymer flow into two separate channels 185A and 185B which extend to a first polymer inlet 180A and a second polymer inlet 180B of the actual mixing device 162. Further, the catalyst channel 158 extends from the catalyst flow meter 160 to the mixing device 162.

The mixing device comprises a drive 177, typically an electric motor, a gearbox 178, and the mixing head 179. The motor drives a rotatable mixing member 250 inside a mixing chamber 181 of the mixing head. The mixing member rotates as indicated by arrow 251. The advantage of the rotatable mixing member 250 is that the head loss as a result of the mixing is limited. This prevents a loss of discharge which would otherwise occur with a static mixing device.

The system 100 further comprises a purge device 230 positioned downstream of the downstream pump 122, more in particular just downstream of the mixing device 162 and upstream of the mould.

The purge device 230 is configured for purging a quantity of material prior to the injection of the polymer into the mould. The purge device also purges a quantity of material after injection of the polymer into the mould.

From the purge device 230, a channel 187 extends to the mould.

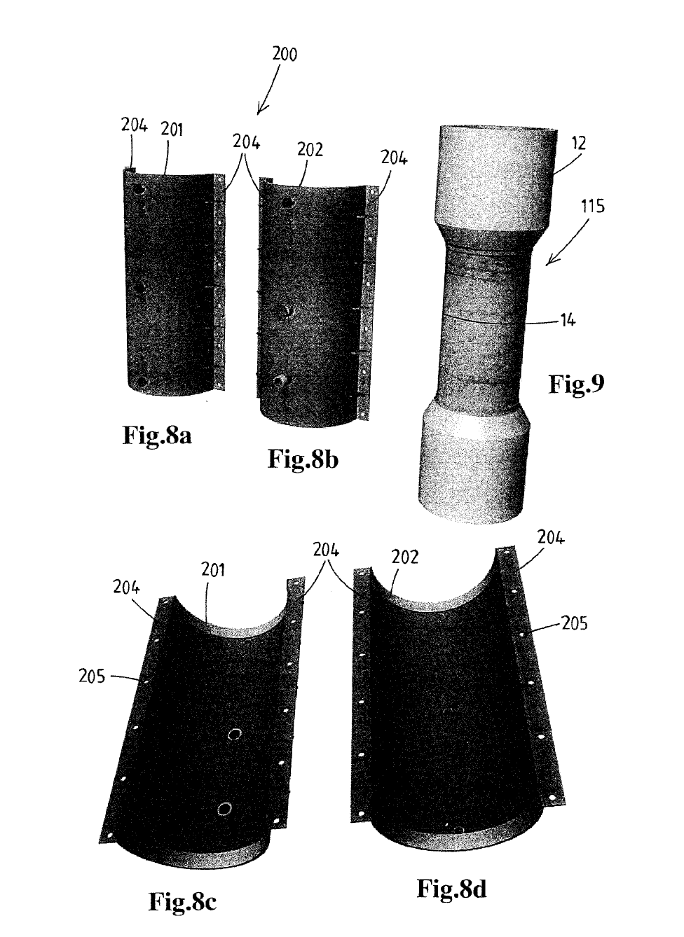

Turning to FIGS. 8A, 8B, 8C, 8D, a mould 200 is shown. The mould 200 comprises a first semi-cylindrical mould half 201 and a second semi-cylindrical mould half 202. At least one connector for the channel 187 coming from the mixing chamber 181. The mould halves 201, 202 are provided with flanges 204 having holes 205. With the flanges the mould haves can be firmly connected to one another via bolts which extend through the holes 205.

Turning to FIG. 9, the welding zone 14 is shown and a FJC area 115 in which the FJC is to be made. The mould halves fit around the pipes 10, 12. On a J-lay vessel, the suspended pipeline is mostly oriented vertically or at a slight angle to the vertical. However, an FJC may also be manufactured on deck when multiple small pipe sections are welded into a single multi-joint pipe section. In this case, the pipes and the mould 200 generally extend horizontally during the making of the FJC. On a S-lay vessel, the pipes also extend horizontally during the making of an FJC.

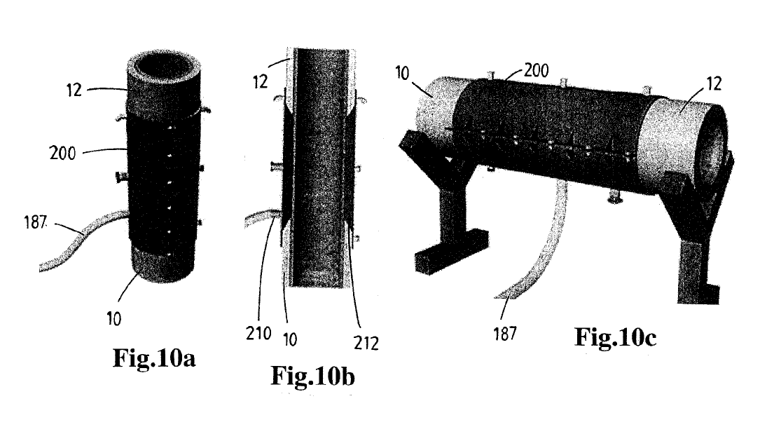

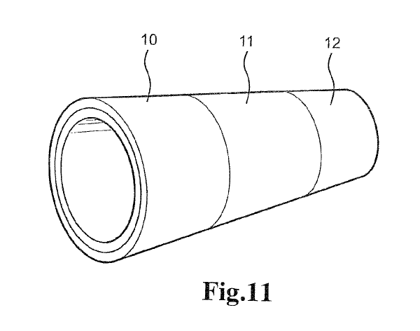

Turning to FIGS. 10A, 10B and 10C, the mould 200 is shown when mounted around the pipeline or pipe sections 10,12. The channel 187 is connected to a connector on the mould. The volume 212 inside the mould extends around the pipeline and around the welding zone.

FIG. 10B shows a vertical arrangement and FIG. 100 shows a horizontal arrangement.

When the FJC is made, the following steps are performed. A quantity of polymer is heated. Next, the heated polymer is pumped into the storage compartment 106 of the ejection device 108 with the at least one upstream pump 104. The filling of the storage compartment takes place outside the critical path. In the storage compartment, the heated quantity of polymer may be in waiting for a certain time period and is being held at the required temperature during that time period.

Next, the heated polymer is ejected from the storage compartment 106 by the ejection device in a relatively short period of time. Next, the operating pressure of the ejected polymer is increased with the downstream pump 122 which is positioned downstream from the ejection device.

The heated ejected polymer passes the flow meter 125 and is mixed with the catalyst in the mixing device 162. Subsequently, the polymer is injected into the mould 200 which is positioned at a Field Joint around a pipeline or pipe sections 10,12. Subsequently the polymer sets for forming the Field Joint Coating. After the curing the mould is removed and the FJC 11 is ready. This situation is shown in FIG. 12.

With a silicone material the polymer is heated to a temperature of at least 60 degrees Celsius, in particular to a temperature between 75-85 degrees Celsius. This significantly reduces the viscosity.

Typically, the ejection device ejects the quantity of polymer at a rate of at least 40 kg/minute. In this way the FJC can be made quite fast.

The ejection device may eject the quantity of polymer in relatively short time period, in particular a time period of less than two minutes, in particular less than 1 minute. The curing in the mould takes place in a time period of less than 10 minutes, in particular less than five minutes. The elapsed time between the start of the ejection process from the storage compartment 106 and the end of the curing process may be less than six minutes.

Typically, the coating of the pipeline is pre-processed prior to the making of the FJC. The pre-processing comprises performing pre-processing steps comprising one or more of:
cleaning the pipeline coating with an abrasive action, typically sandblasting,
heating the pipeline coating with a coating heating device,
changing the surface energy of the pipeline coating by performing a plasma-treating step, wherein an ionized material is sprayed onto the coating.

A silicone material may be used, but other polymers are also conceivable. Silicone is a polymer which has only a mild exothermic reaction during curing. Other 2-component polymers which do not have only a mild exothermic reaction may also be used. Silicone remains its integrity up to a temperature of 150 degrees.

Generally, the present invention will be carried out on board a pipeline laying vessel or on a spoolyard.

The present invention is suitable to provide a fast injection of the polymer coating material into the mould for manufacturing the coating. The present invention is also suitable to inject the polymer in a reliable way.

The present invention provides a specialized ejection device for ejecting the polymer. The general containers 210 for storing the polymer may be simple containers and are not used for in the critical path of the pipeline laying process.

It is noted that the system 100 may be carried out as a single component system, i.e. without a catalyst.

In an embodiment, the present invention is carried out with a thixotropic polymer. The present invention was found to work particularly well with silicone material, more in particular a silicone material which comprises hollow microspheres dispersed within the silicone material. The microspheres are typically from glass. The microspheres provide advantages which are described above.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

The mere fact that certain measures are recited in mutually different dependent claims does not indicate that a combination of these measures cannot be used to advantage.

1.-41. (canceled)

42. A system for manufacturing a Field Joint Coating, the system comprising:
a heating device for heating a quantity of a polymer,
an upstream pump for pumping the quantity of heated polymer into a storage compartment of an ejection device,
the ejection device which is constructed for each time ejecting the quantity of heated polymer from its storage compartment, the ejection device comprising:
a barrel which defines the storage compartment, the barrel being reinforced and configured for repeated use,
a plunger,
an actuator for driving the plunger through the barrel from a start position to an end position for emptying the storage compartment, and
a discharge opening
a downstream pump positioned downstream from the ejection device,
the downstream pump being constructed for increasing the operating pressure of the ejected polymer for injection of the polymer into the mould, and
the mould which is configured to be positioned at a field joint around a pipeline or a pipe section.

43. The system according to claim 42, wherein the heating device is separate from the upstream pump and is located upstream from the upstream pump, and wherein the polymer is heated prior to entering the upstream pump.

44. The system according to claim 42, comprising a jacket which extends around the barrel and a further heating system for heating a hot fluid, the heating system being configured for pumping the hot fluid through the jacket for maintaining the elevated temperature of the heated polymer inside the barrel.

45. The system according to claim 42, wherein a volume of the storage compartment is at least 90 percent of a volume of the mould when positioned around the pipeline or pipe section, or, when the system comprises multiple ejection devices for ejecting the heated polymer, the ejection devices being arranged in parallel, the combined volume of the storage compartments of these ejection devices is at least 90 percent of the volume of the mould.

46. The system according to claim 42, the system being a 2-component system, the system further comprising a catalyst supply for supplying a catalyst for a curing reaction of the polymer and a mixing device for mixing the catalyst with the heated polymer, wherein in particular the mixing device is positioned downstream of the downstream pump.

47. The system according to claim 46, wherein the catalyst supply comprises a catalyst storage compartment, a catalyst discharge opening and a catalyst pump for pumping the catalyst into the mixing device.

48. The system according to claim 42, further comprising:
an oven,
a plurality of containers containing the polymer, wherein the containers are placed in the oven for a period of time for heating the polymer,
wherein the upstream pump comprises:
an emptying position for the heated container,
a second plunger positioned upstream from the first plunger and being configured to move through the container, and
a second actuator for driving the plunger from a first position to a second position.

49. The system according to claim 46, wherein the mixing device comprises a polymer inlet, a catalyst inlet, a mixing chamber and a rotatable mixing member positioned inside the chamber, the rotatable mixing organ being driven by a drive.

50. A method for manufacturing a Field Joint Coating, the method comprising:
heating a quantity of polymer,
pumping the heated polymer into a storage compartment of an ejection device with at least one upstream pump, the ejection device being constructed for each time ejecting the quantity of heated polymer from its storage compartment, the ejection device comprising:
a barrel which defines the storage compartment, the barrel being reinforced and configured for repeated use,
a plunger,
an actuator for driving the plunger through the barrel from a start position to an end position for emptying the storage compartment, and
a discharge opening,
ejecting the heated polymer from the storage compartment by the ejection device in a relatively short period of time,
increasing the operating pressure of the ejected polymer with a downstream pump which is positioned downstream from the ejection device,
injecting the polymer into a mould which is positioned at a field joint around a pipeline or a pipe section, and
letting the polymer set for forming the field joint coating.

51. The method according to claim 50, wherein the heating device is separate from the upstream pump and is located upstream from the upstream pump, and wherein the polymer is heated prior to entering the upstream pump and outside a critical path.

52. The method according to claim 50, wherein a volume of the storage compartment is at least 90 percent of a volume of the mould when positioned around the pipeline or pipe section, or, when the system comprises multiple ejection devices for ejecting the heated polymer, the ejection devices being positioned in parallel, the combined volume of the storage compartments of these ejection devices is at least 90 percent of the volume of the mould.

53. The method according to claim 50, wherein the polymer is a silicone material, in particular a silicone material comprising glass microspheres dispersed within the silicone material.

54. The method according to claim 50, wherein the polymer is mixed with a catalyst for catalysing the curing process, and wherein the catalyst is mixed with the polymer in a mixing device which is located downstream of the downstream pump.

55. The method according to claim 50, wherein the heated polymer is pumped into the storage compartment of the ejection device during:
a) the positioning of a pipe section in the firing line, or
b) aligning the pipe section with the pipeline, or
c) welding the pipe section to the pipeline, or
d) inspecting the weld, or
e) testing the weld, or
wherein the heated polymer is ready to be ejected from the storage compartment when the FJC is to be made.

56. The method according to claim 50, wherein the polymer is a thixotropic polymer.

57. The method according to claim 50, comprising performing pre-processing steps on a pipeline coating of the pipeline or pipe section adjacent to the FJC, the pre-processing steps comprising one or more of:
cleaning the pipeline coating with an abrasive action,
heating the pipeline coating with a coating heating device,
changing the surface energy of the pipeline coating by performing a plasma-treating step, wherein an ionized material is sprayed onto the coating.

58. The method according to claim 50, wherein the polymer is a polymer which has no exothermic reaction during curing or only a mildly exothermic reaction during curing.

59. The method according to claim 50, the method being carried out on board a pipeline laying vessel or on a spoolyard.

60. The method according to claim 50, comprising pumping the quantity of heated polymer into a storage compartment of an ejection device prior to the injection of the polymer into a mould.

61. The method according to claim 50, wherein the ejection device controls both pressure and discharge rate.
